(19) United States
(12) Patent Application Publication
(10) Pub. No.: US 2017/0137695 A1
(43) Pub. Date: May 18, 2017

(54) LIGNOSULFONATES AS VISCOSIFIERS

(71) Applicant: Trican Well Service, Ltd., Calgary (CA)

(72) Inventors: Nisa Monica Shaffer, Conroe, TX (US); Marvin Vincent Solomon, SR., Conroe, TX (US)

(73) Assignee: Trican Well Service, Ltd., Calgary (CA)

(21) Appl. No.: 14/941,509

(22) Filed: Nov. 13, 2015

(51) Int. Cl. C09K 8/467; E21B 33/14; C04B 22/14

(52) U.S. Cl. CPC C09K 8/467; C04B 22/14; E21B 33/14

(57) ABSTRACT

By adding a lignosulfonate preferably magnesium lignosulfonate to water and subjecting the mixture to shear a viscous fluid is created. The lignosulfonate increases the viscosity of the water at least to the point where the fluid is viscous enough to maintain the cement in a solution without free water yet not so viscous as to prevent the pumps from moving the viscous fluid slurry and thereby damaging the pumps. The fluid is sufficiently viscous to enable the fluid to conduct the cement slurry through the wellbore and into the formation without duning or otherwise allowing the cement to settle out. Additionally the fluid continues to remain viscous and retain the cement in slurry at temperatures in excess of 225° F.

### BACKGROUND

Cementing is one of the most critical steps in a well completion. The primary objective of cementing is to provide zonal isolation. Cementing is the process of mixing a slurry of cement, additives, and water and pumping it down through casing to critical points in annulus around the casing or an open hole below the casing string. The two principal functions of the cementing process are to restrict fluid movement between the formations and to bond and support the casing. The properties of the cement slurry and its behavior depend upon the components and additives in the cement slurry

It is been found that a maximum strength cement occurs in the water to cement ratio of about 2.8 gallons per sack. This is the minimum amount of water necessary to fully hydrate and chemically react with the cement. However a cement slurry mixed at this water rate has a very high viscosity and cannot be pumped into the well. Alternatively if too much water is used aid in pumping and displacement, low strength and a very high free water quantity will occur. Free water is defined as water that is not needed by the cement for reaction. The high free water content when flow stops the water separates out to the top of the cement column. Separation may occur at the top of a long column or in pockets in highly deviated wells.

Controlling the cement slurry density is critical for placing the cement into the annular regions of the wellbore around the casing while a separated water/cement slurry has regions of very high density and very low density. The best cementing jobs are accomplished when a uniformly dense cement slurry is fully and evenly placed around the casing.

### SUMMARY

It has been found that it is possible to prevent the cement and water separation, i.e. a free water condition, and enhance cement transport by adding a viscosifier to the fluid. The viscosifier is used to make the fluid thicker and thus more able to move the dense cement particles through the wellbore and into the annular region between the casing and the wellbore.

An ideal viscosifier is viscosifier that when added to a fluid, such as water, increases the viscosity of the water at least to the point where the fluid is viscous enough to maintain the cement in a solution without free water yet not so viscous as to prevent the pumps from moving the viscous fluid slurry and thereby damaging the pumps. Additionally such a viscosifier is relatively inexpensive.

It has been found that the lignosulfonates, in particular magnesium lignosulfonate, when stirred or heated for some period of time and in sufficient quantities in the presence of water tend to make the water a viscous fluid where the viscosity and the duration of the viscosity of the water is sufficient to maintain the cement in a solution without free water.

In an embodiment of the current invention it was found that a solution consisting of 0.6% by weight of cement of magnesium lignosulfonate, cement, and water when agitated for 20 minutes creates a sufficiently viscous fluid to maintain the cement in a solution. While magnesium lignosulfonate is preferred it is also found that other lignosulfonate's, such as calcium lignosulfonate, may also be used.

In another embodiment of the current invention it was found that a solution consisting of 0.6% of magnesium lignosulfonate by weight of cement, cement, and water when heated, such as when a cement is pumped into a hot well, creates a sufficiently viscous fluid to maintain the cement in a solution.

In other embodiments of the current invention it was found that while 0.6% of magnesium lignosulfonate by weight of cement is preferable other amounts of lignosulfonates work as well. For instance as little as 0.2% and is much as 1.2% of magnesium lignosulfonate appear to produce the desired result of increasing the viscosity of the cementing fluid to a level sufficient to transport proppant.

### BRIEF DESCRIPTION OF THE DRAWINGS

FIG. 1 depicts the rheological profile of a cementing fluid system having a viscosifier in an amount of 0.3% magnesium lignosulfonate stirred for 20 minutes and up to 180° F.

FIG. 2 depicts the rheological profile of a cementing fluid system having a viscosifier in an amount of 0.6% magnesium lignosulfonate stirred for 20 minutes and up to 180° F.

FIG. 3 depicts the rheological profile of a cementing fluid system having a viscosifier in an amount of 0.6% magnesium lignosulfonate stirred for 70 minutes and up to 180° F.

FIG. 4 depicts the rheological profile of a cementing fluid system having a viscosifier in an amount of 0.0% magnesium lignosulfonate stirred for 30 minutes at room temperature.

FIG. 5 depicts the rheological profile of a cementing fluid system having a viscosifier in an amount of 0.6% magnesium lignosulfonate stirred for 30 minutes at room temperature.

FIG. 6 depicts the rheological profile of a cementing fluid system having a viscosifier in an amount of 0.4% magnesium lignosulfonate, 35% silica flour, 0.125% sodium glucoheptonate, stirred for 30 minutes and up to 225° F.

FIG. 7 depicts the rheological profile of a cementing fluid system having a viscosifier in an amount of 0.6% calcium lignosulfonate stirred for 70 minutes and up to 180° F.

FIG. 8 depicts the rheological profile of a cementing fluid system having a viscosifier in an amount of 0.6% calcium lignosulfonate 0.125% sodium glucoheptonate, stirred for 70 minutes and up to 180° F.

FIG. 9 depicts the rheological profile of a cementing fluid system having a viscosifier in an amount of 0.6% calcium lignosulfonate stirred for 30 minutes at room temperature.

FIG. 10 depicts the rheological profile of a cementing fluid system having a viscosifier in an amount of 0.6% calcium lignosulfonate, 0.125% sodium glucoheptonate, stirred for 30 minutes at room temperature.

FIG. 11 depicts the rheological profile of a cementing fluid system having a viscosifier in an amount of 0.6% ammonium lignosulfonate stirred for 70 minutes and up to 180° F.

FIG. 12 depicts the rheological profile of a cementing fluid system having a viscosifier in an amount of 0.6% sodium lignosulfonate stirred for 70 minutes and up to 180° F.

FIG. 13 depicts the rheological profile of a cementing fluid system having a viscosifier in an amount of 0.6% sodium lignosulfonate stirred for 30 minutes at room temperature.

FIG. 14 depicts the rheological profile of a cementing fluid system having a viscosifier in an amount of 0.6% ammonium lignosulfonate stirred for 30 minutes at room temperature.

### DETAILED DESCRIPTION

The description that follows includes exemplary apparatus, methods, techniques, or instruction sequences that embody techniques of the inventive subject matter. However, it is understood that the described embodiments may be practiced without these specific details.

A viscosifying agent may be magnesium lignosulfonate or calcium lignosulfonate.

Each of the tests described in FIGS. 1 through 5 is conducted in accordance with API Spec 10B-2, Second Edition, Section 11. Typically the test is conducted as follows using a high pressure, high temperature viscometer. The slurry, as described is mixed according to American Petroleum Institute, usually referred to as API, standards. Once mixed the slurry is poured into a cell which is then closed. A magnetic drive is secured to the cell and the cell is lowered into a housing. With the cell secured in the housing the housing is moved into the viscometer. Inlet and outlet hoses are attached to the housing and the viscometer is closed. The housing is filled with oil and all air is purged from the housing. The pressure relief valve is closed and the test is started. The test typically consist of the viscometer running a set of sweeps where the viscometer increases the revolutions at which it turns beginning with 3 RPM for 10 seconds and it takes a reading of the deflection of the bob. The angle at which the vane on the bob is deflected directly corresponds to the viscosity of the fluid. The viscometer then increases the revolutions to 6 RPM for 10 seconds and then taking another reading of the deflection of the bob. The viscometer continues this process taking readings at 30, 60, 100, 200 and 300 RPM and then stepping back down to each of the RPM ranges from 300 to 3 RPM. The viscometer then begins conditioning the fluid, where conditioning consists of stirring the fluid 100 RPM and may include heating the fluid to a predetermined temperature over preset time. Where the temperature may be 180° F. and the duration of the conditioning is 20 minutes.

FIG. 1 depicts the rheological profile of a cementing fluid system having a viscosifier in an amount of 0.3% magnesium lignosulfonate by weight of cement, 94 pounds of cement, and 4.39 gallons of water. At the beginning of the test the fluid was at 80° F. and the pressure was 400 psi. In the initial sweep the bob deflection at 3 RPM was 8.4°, the bob deflection at 6 RPM was 12.2°, the bob deflection at 30 RPM was 24.1°, the bob deflection at 60 RPM was 31.9°, the bob deflection at 100 RPM was 39.4°, the bob deflection at 200 RPM was 56.4°, and the bob deflection at 300 RPM was 70.2°. The ramp time was 20 minutes during which the mixture was stirred at 100 RPM, the temperature was increased to 180° F., and the pressure was increased to 4500 psi. Once the desired temperature, pressure, and mixing time were reached another sweep was conducted where it 3 RPM the bob deflection was 18°, at 6 RPM the bob deflection was 24.7°, at 30 RPM the bob deflection was 48.6°, at 60 RPM the bob deflection was 61°, at 100 RPM the bob deflection was 68°, at 200 RPM the bob deflection was 77.9 RPM and 300 RPM the Bob deflection was 89.4°.

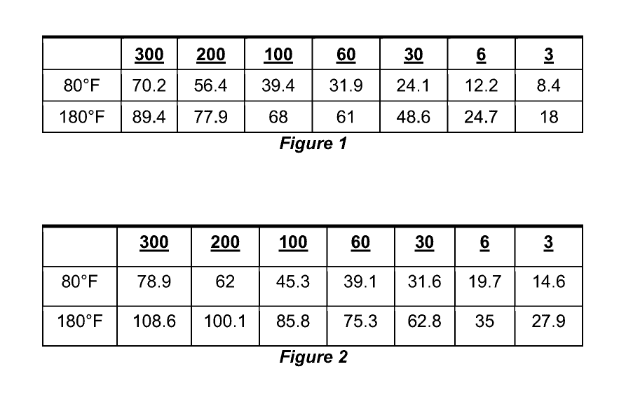

FIG. 2 depicts the rheological profile of a cementing fluid system having a viscosifier in an amount of 0.6% magnesium lignosulfonate by weight of cement, 94 pounds of cement, and 4.39 gallons of water. At the beginning of the test the fluid was at 80° F. and the pressure was 400 psi. In the initial sweep the bob deflection at 3 RPM was 14.6°, the bob deflection at 6 RPM was 19.7°, the bob deflection at 30 RPM was 31.6°, the bob deflection at 60 RPM was 39.1°, the bob deflection at 100 RPM was 45.3°, the bob deflection at 200 RPM was 62°, and the bob deflection at 300 RPM was 78.9°. The ramp time was 20 minutes during which the mixture was stirred at 100 RPM, the temperature was increased to 180° F., and the pressure was increased to 4500 psi. Once the desired temperature, pressure, and mixing time were reached another sweep was conducted where it 3 RPM the bob deflection was 27.9°, at 6 RPM the bob deflection was 35°, at 30 RPM the bob deflection was 62.8°, at 60 RPM the bob deflection was 75.3°, at 100 RPM the bob deflection was 85.8°, at 200 RPM the bob deflection was 100.1°, and 300 RPM the bob deflection was 108.6°.

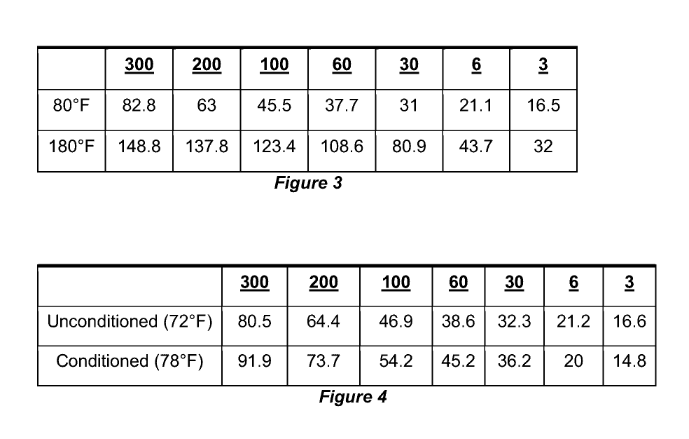

FIG. 3 depicts the rheological profile of a cementing fluid system having a viscosifier in an amount of 0.6% magnesium lignosulfonate by weight of cement, 94 pounds of cement, and 4.39 gallons of water. At the beginning of the test the fluid was at 80° F. and the pressure was 400 psi. In the initial sweep the bob deflection at 3 RPM was 16.5°, the bob deflection at 6 RPM was 21.1°, the bob deflection at 30 RPM was 31°, the bob deflection at 60 RPM was 37.7°, the bob deflection at 100 RPM was 45.5°, the bob deflection at 200 RPM was 62°, and the bob deflection at 300 RPM was 82.8°. The ramp time was 70 minutes during which the mixture was stirred at 100 RPM, the temperature was increased to 180° F., and the pressure was increased to 4500 psi. Once the desired temperature, pressure, and mixing time were reached another sweep was conducted where it 3 RPM the bob deflection was 32°, at 6 RPM the bob deflection was 43.7°, at 30 RPM the bob deflection was 80.9°, at 60 RPM the bob deflection was 108.6°, at 100 RPM the bob deflection was 123.4°, at 200 RPM the bob deflection was 137.8°, and 300 RPM the bob deflection was 148.8°.

FIG. 4 depicts the rheological profile of a cementing fluid system having no lignosulfonate, 94 pounds of cement, and 4.39 gallons of water. At the beginning of the test the fluid was at 72° F. and the pressure was 400 psi. In the initial sweep the bob deflection at 3 RPM was 16.6°, the bob deflection at 6 RPM was 21.2°, the bob deflection at 30 RPM was 32.3°, the bob deflection at 60 RPM was 38.6°, the bob deflection at 100 RPM was 46.9°, the bob deflection at 200 RPM was 64.4°, and the bob deflection at 300 RPM was 80.5°. The ramp time was 30 minutes during which the mixture was stirred at 100 RPM, while the fluid was not heated the temperature did increase 6° F. to 78° F. due to frictional heating from stirring during the conditioning. The pressure was increased to 4500 psi. Once the desired pressure and mixing time were reached another sweep was conducted where it 3 RPM the bob deflection was 14.8°, at 6 RPM the bob deflection was 20°, at 30 RPM the bob deflection was 36.2°, at 60 RPM the bob deflection was 45.2°, at 100 RPM the bob deflection was 54.2°, at 200 RPM the bob deflection was 73.7°, and 300 RPM the bob deflection was 91.9°.

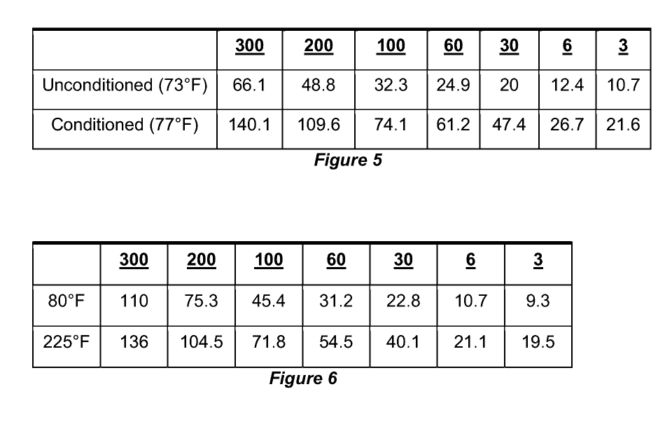

FIG. 5 depicts the rheological profile of a cementing fluid system having a viscosifier in an amount of 0.6% magnesium lignosulfonate by weight of cement, 94 pounds of cement, and 4.39 gallons of water. At the beginning of the test the fluid was at 73° F. and the pressure was 400 psi. In the initial sweeps the bob deflection at 3 RPM was 10.7°, the bob deflection at 6 RPM was 12.4°, the bob deflection at 30 RPM was 20°, the bob deflection at 60 RPM was 24.9°, the bob deflection at 100 RPM was 32.3°, the bob deflection at 200 RPM was 48.8°, and the bob deflection at 300 RPM was 66.1°. The ramp time was 30 minutes during which the mixture was stirred at 100 RPM, while the fluid was not heated the temperature did increase 4° F. to 77° F. due to frictional heating from stirring during the conditioning. The pressure was increased to 4500 psi. Once the desired pressure and mixing time were reached another sweep was conducted where it 3 RPM the bob deflection was 21.6°, at 6 RPM the bob deflection was 26.7°, at 30 RPM the bob deflection was 47.4°, at 60 RPM the bob deflection was 61.2°, at 100 RPM the bob deflection was 74.1°, at 200 RPM the bob deflection was 109.6°, and 300 RPM the bob deflection was 140.1°.

FIG. 6 depicts the rheological profile of a cementing fluid system having a viscosifier in an amount of 0.4% magnesium lignosulfonate by weight of cement, 94 pounds of cement, 4.39 gallons of water, 35% silica flour by weight of cement, and 0.125% sodium glucoheptonate by weight of cement. At the beginning of the test the fluid was at 80° F. and the pressure was 400 psi. In the initial sweeps the bob deflection at 3 RPM was 9.3°, the bob deflection at 6 RPM was 10.7°, the bob deflection at 30 RPM was 22.8°, the bob deflection at 60 RPM was 31.2°, the bob deflection at 100 RPM was 45.4°, the bob deflection at 200 RPM was 75.3°, and the bob deflection at 300 RPM was 110°. The ramp time was 30 minutes during which the mixture was stirred at 100 RPM, the temperature was increased to 225° F., and the pressure was increased to 4500 psi. Once the desired pressure and mixing time were reached another sweep was conducted where at 3 RPM the bob deflection was 19.5°, at 6 RPM the bob deflection was 21.1°, at 30 RPM the bob deflection was 40.1°, at 60 RPM the bob deflection was 54.5°, at 100 RPM the bob deflection was 71.8°, at 200 RPM the bob deflection was 104.5°, and 300 RPM the bob deflection was 136°.

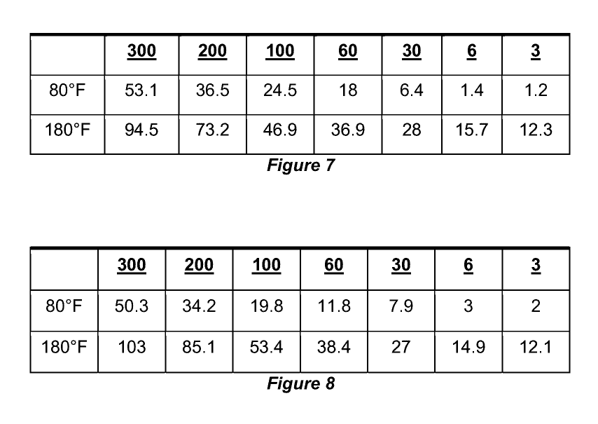

FIG. 7 depicts the rheological profile of a cementing fluid system having a viscosifier in an amount of 0.6% calcium lignosulfonate by weight of cement, 94 pounds of cement, and 4.39 gallons of water. At the beginning of the test the fluid was at 80° F. and the pressure was 400 psi. In the initial sweeps the bob deflection at 3 RPM was 1.2°, the bob deflection at 6 RPM was 1.4°, the bob deflection at 30 RPM was 6.4°, the bob deflection at 60 RPM was 18°, the bob deflection at 100 RPM was 24.5°, the bob deflection at 200 RPM was 36.5°, and the bob deflection at 300 RPM was 53.1°. The ramp time was 70 minutes during which the mixture was stirred at 100 RPM, the temperature was increased to 180° F., and the pressure was increased to 4500 psi. Once the desired pressure, temperature, and mixing time were reached another sweep was conducted where at 3 RPM the bob deflection was 12.3°, at 6 RPM the bob deflection was 15.7°, at 30 RPM the bob deflection was 28°, at 60 RPM the bob deflection was 36.9°, at 100 RPM the bob deflection was 46.9°, at 200 RPM the bob deflection was 73.2°, and 300 RPM the bob deflection was 94.5°.

FIG. 8 depicts the rheological profile of a cementing fluid system having a viscosifier in an amount of 0.6% calcium lignosulfonate by weight of cement, 0.125% sodium glucoheptonate by weight of cement, 94 pounds of cement, and 4.39 gallons of water. At the beginning of the test the fluid was at 80° F. and the pressure was 400 psi. In the initial sweeps the bob deflection at 3 RPM was 2°, the bob deflection at 6 RPM was 3°, the bob deflection at 30 RPM was 7.9°, the bob deflection at 60 RPM was 11.8°, the bob deflection at 100 RPM was 19.8°, the bob deflection at 200 RPM was 34.2°, and the bob deflection at 300 RPM was 50.3°. The ramp time was 70 minutes during which the mixture was stirred at 100 RPM, the temperature was increased to 180° F., and the pressure was increased to 4500 psi. Once the desired pressure, temperature, and mixing time were reached another sweep was conducted where at 3 RPM the bob deflection was 12.1°, at 6 RPM the bob deflection was 14.9°, at 30 RPM the bob deflection was 27°, at 60 RPM the bob deflection was 38.4°, at 100 RPM the bob deflection was 53.4°, at 200 RPM the bob deflection was 85.1°, and 300 RPM the bob deflection was 103°.

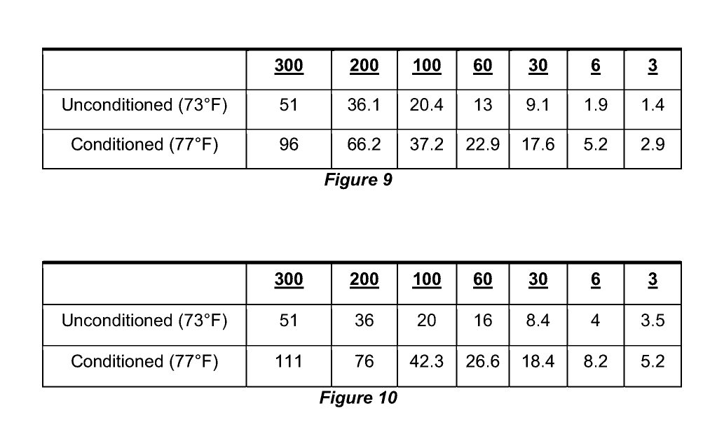

FIG. 9 depicts the rheological profile of a cementing fluid system having a viscosifier in an amount of 0.6% calcium lignosulfonate by weight of cement, 94 pounds of cement, and 4.39 gallons of water. At the beginning of the test the fluid was at 73° F. and the pressure was 400 psi. In the initial sweeps the bob deflection at 3 RPM was 1.4°, the bob deflection at 6 RPM was 1.9°, the bob deflection at 30 RPM was 9.1°, the bob deflection at 60 RPM was 13°, the bob deflection at 100 RPM was 20.4°, the bob deflection at 200 RPM was 36.1°, and the bob deflection at 300 RPM was 51°. The ramp time was 30 minutes during which the mixture was stirred at 100 RPM, while the fluid was not heated the temperature did increase 4° F. to 77° F. due to frictional heating from stirring during the conditioning. The pressure was increased to 4500 psi. Once the desired pressure and mixing time were reached another sweep was conducted where at 3 RPM the bob deflection was 2.9°, at 6 RPM the bob deflection was 5.2°, at 30 RPM the bob deflection was 17.6°, at 60 RPM the bob deflection was 22.9°, at 100 RPM the bob deflection was 37.2°, at 200 RPM the bob deflection was 66.2°, and 300 RPM the bob deflection was 96°.

FIG. 10 depicts the rheological profile of a cementing fluid system having a viscosifier in an amount of 0.6% calcium lignosulfonate by weight of cement, 0.125% sodium glucoheptonate by weight of cement, 94 pounds of cement, and 4.39 gallons of water. At the beginning of the test the fluid was at 73° F. and the pressure was 400 psi. In the initial sweeps the bob deflection at 3 RPM was 3.5°, the bob deflection at 6 RPM was 4°, the bob deflection at 30 RPM was 8.4°, the bob deflection at 60 RPM was 16°, the bob deflection at 100 RPM was 20°, the bob deflection at 200 RPM was 36°, and the bob deflection at 300 RPM was 51°. The ramp time was 30 minutes during which the mixture was stirred at 100 RPM, while the fluid was not heated the temperature did increase 4° F. to 77° F. due to frictional heating from stirring during the conditioning. The pressure was increased to 4500 psi. Once the desired pressure and mixing time were reached another sweep was conducted where at 3 RPM the bob deflection was 5.2°, at 6 RPM the bob deflection was 8.2°, at 30 RPM the bob deflection was 18.4°, at 60 RPM the bob deflection was 26.6°, at 100 RPM the bob deflection was 42.3°, at 200 RPM the bob deflection was 76°, and 300 RPM the bob deflection was 111°.

FIG. 11 depicts the rheological profile of a cementing fluid system having a viscosifier in an amount of 0.6% ammonium lignosulfonate by weight of cement, 94 pounds of cement, and 4.39 gallons of water. At the beginning of the test the fluid was at 80° F. and the pressure was 400 psi. In the initial sweeps the bob deflection at 3 RPM was 2.6°, the bob deflection at 6 RPM was 3.1°, the bob deflection at 30 RPM was 5.5°, the bob deflection at 60 RPM was 11.4°, the bob deflection at 100 RPM was 16.5°, the bob deflection at 200 RPM was 28.2°, and the bob deflection at 300 RPM was 44.7°. The ramp time was 70 minutes during which the mixture was stirred at 100 RPM, the fluid was heated to 180° F., and the pressure was increased to 4500 psi. Once the desired pressure, temperature, and mixing time were reached another sweep was conducted where at 3 RPM the bob deflection was 7°, at 6 RPM the bob deflection was 8.4°, at 30 RPM the bob deflection was 13.1°, at 60 RPM the bob deflection was 20.3°, at 100 RPM the bob deflection was 24.4°, at 200 RPM the bob deflection was 40.1°, and 300 RPM the bob deflection was 47.2°.

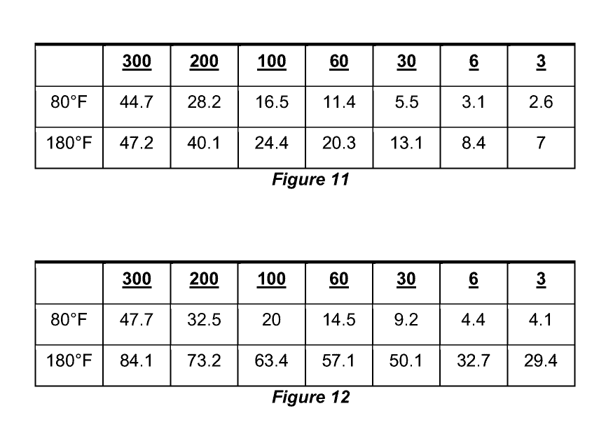

FIG. 12 depicts the rheological profile of a cementing fluid system having a viscosifier in an amount of 0.6% sodium lignosulfonate by weight of cement, 94 pounds of cement, and 4.39 gallons of water. At the beginning of the test the fluid was at 80° F. and the pressure was 400 psi. In the initial sweeps the bob deflection at 3 RPM was 4.1°, the bob deflection at 6 RPM was 4.4°, the bob deflection at 30 RPM was 9.2°, the bob deflection at 60 RPM was 14.5°, the bob deflection at 100 RPM was 20°, the bob deflection at 200 RPM was 32.5°, and the bob deflection at 300 RPM was 47.7°. The ramp time was 70 minutes during which the mixture was stirred at 100 RPM, the fluid was heated to 180° F., and the pressure was increased to 4500 psi. Once the desired pressure, temperature, and mixing time were reached another sweep was conducted where at 3 RPM the bob deflection was 29.4°, at 6 RPM the bob deflection was 32.7°, at 30 RPM the bob deflection was 50.1°, at 60 RPM the bob deflection was 57.1°, at 100 RPM the bob deflection was 63.4°, at 200 RPM the bob deflection was 73.2°, and 300 RPM the bob deflection was 84.1°.

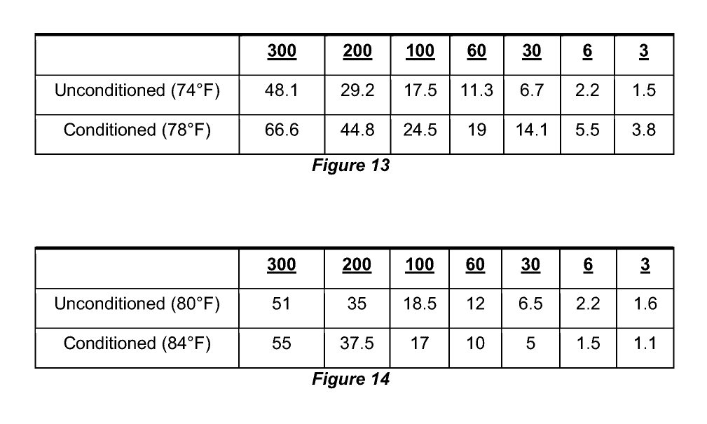

FIG. 13 depicts the rheological profile of a cementing fluid system having a viscosifier in an amount of 0.6% sodium lignosulfonate by weight of cement, 94 pounds of cement, and 4.39 gallons of water. At the beginning of the test the fluid was at 74° F. and the pressure was 400 psi. In the initial sweeps the bob deflection at 3 RPM was 1.5°, the bob deflection at 6 RPM was 2.2°, the bob deflection at 30 RPM was 6.7°, the bob deflection at 60 RPM was 11.3°, the bob deflection at 100 RPM was 17.5°, the bob deflection at 200 RPM was 29.2°, and the bob deflection at 300 RPM was 48.1°. The ramp time was 30 minutes during which the mixture was stirred at 100 RPM, while the fluid was not heated the temperature did increase 4° F. to 78° F. due to frictional heating from stirring during the conditioning. The pressure was increased to 4500 psi. Once the desired pressure and mixing time were reached another sweep was conducted where at 3 RPM the bob deflection was 3.8°, at 6 RPM the bob deflection was 5.5°, at 30 RPM the bob deflection was 14.1°, at 60 RPM the bob deflection was 19°, at 100 RPM the bob deflection was 24.5°, at 200 RPM the bob deflection was 44.8°, and 300 RPM the bob deflection was 66.6°.

FIG. 14 depicts the rheological profile of a cementing fluid system having a viscosifier in an amount of 0.6% ammonium lignosulfonate by weight of cement, 94 pounds of cement, and 4.39 gallons of water. At the beginning of the test the fluid was at 80° F. and the pressure was 400 psi. In the initial sweeps the bob deflection at 3 RPM was 1.6°, the bob deflection at 6 RPM was 2.2°, the bob deflection at 30 RPM was 6.5°, the bob deflection at 60 RPM was 12°, the bob deflection at 100 RPM was 18.5°, the bob deflection at 200 RPM was 35°, and the bob deflection at 300 RPM was 51°. The ramp time was 30 minutes during which the mixture was stirred at 100 RPM, while the fluid was not heated the temperature did increase 4° F. to 80° F. due to frictional heating from stirring during the conditioning. The pressure was increased to 4500 psi. Once the desired pressure and mixing time were reached another sweep was conducted where at 3 RPM the bob deflection was 1.1°, at 6 RPM the bob deflection was 1.5°, at 30 RPM the bob deflection was 5°, at 60 RPM the bob deflection was 10°, at 100 RPM the bob deflection was 17°, at 200 RPM the bob deflection was 37.5°, and 300 RPM the bob deflection was 55°.

As can be seen from the testing the magnesium lignosulfonate was most effective in an amount of 0.6% by weight of cement and where the mixture could be stirred or mixed for 30 minutes.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A well treatment fluid comprising:
a water,
a cement,
a lignosulfonate, and
subjecting the fluid to shear.

2. The well treatment fluid of claim 1 wherein, the fluid is subjected to shear for from about 20 minutes to about 70 minutes.

3. The well treatment fluid of claim 1 wherein, the fluid is subjected to shear for about 30 minutes.

4. The well treatment fluid of claim 1 wherein, the lignosulfonate is magnesium lignosulfonate.

5. The well treatment fluid of claim 1 wherein, the lignosulfonate is calcium lignosulfonate.

6. A method of cementing a well comprising,
mixing a water with a lignosulfonate,
adding a cement, and
pumping the mixture into a wellbore,
wherein pumping the mixture into a wellbore subjects the mixture to a shear.

7. The method of cementing a well of claim 6 wherein, the fluid is subjected to shear for from about 20 minutes to about 70 minutes.

8. The method of cementing a well of claim 6 wherein, the fluid is subjected to shear for about 30 minutes.

9. The method of cementing a well of claim 6 wherein, the lignosulfonate is magnesium lignosulfonate.

10. The method of cementing a well of claim 6 wherein, the lignosulfonate is calcium lignosulfonate.
